(19) United States
(12) Patent Application Publication
(10) Pub. No.: US 2014/0262872 A1
(43) Pub. Date: Sep. 18, 2014

(54) DISK RETAINING PACKAGE

(71) Applicant: SONOCO DEVELOPMENT, INC., Hartsville, SC (US)

(72) Inventor: Neil Helm, DeKalb, IL (US)

(73) Assignee: Sonoco Development, Inc., Hartsville, SC (US)

(21) Appl. No.: 13/803,287

(22) Filed: Mar. 14, 2013

(51) Int. Cl. G11B 33/04

(52) U.S. Cl. CPC G11B 33/0427
USPC 206/308.1

(57) ABSTRACT

A blister package is provided for retaining a disc or other article. The blister package includes a thermoformed plate having a front side and a back side. A retaining well is formed in the back side of the plate and is dimensionally formed for receiving the disc or other article. At least one engagement clip is integrally formed within the plate and positioned on a periphery of the retaining well. The clip includes a resilient hook portion for surrounding an edge of a disk or article that is received in the retaining well. The hook applies a resilient retaining force on the disk or article in the direction of the back side of the plate such that the hook positions the disk or article in frictional contact with the back side of the plate.

### FIELD OF THE INVENTION

The present device relates to a package for retaining, storing and shipment of a disk or other article. The package may preferably be of the type known as a blister package, a clamshell package, tri-fold package or the like.

### BACKGROUND OF THE INVENTION

It is also known to create packages from a single piece of thin, thermoformed plastic, sometimes called a blister package. One example is U.S. Pat. No. 5,353,935 to Yeager et al. showing a thermoformed blister package having a front bubble forming a product retaining cavity and a rear card structure that is retained within the open back of the formed blister by a series of inwardly directed detents.

A number of package forms are also known for retaining, storing and shipment of disk-like structures, such as media disks for storage of data, including CD's, DVD's, Blue-ray disks, and similar media storage structures. Generally, media disks are round, relatively thin, planer structures made from a plastic material and on which data is recorded by various electronic, magnetic, optical or mechanical methods. Typically, the data may be recorded on a surface layer deposited on one surface or side, although double sided storage disks are known.

U.S. Pat. No. 7,124,422 to Yamagishi et al. shows an injection molded case for storing a media disk having a formed hub structure for engaging with a central opening in the disk. A mechanical assembly is provided adjacent a periphery of the disk retaining area. The mechanical assembly includes a pair of lifting arms that engages the underside periphery of the disk. When activated, the arms push upwardly on an edge of the disk to assist in removal of the disk from engagement with the hub.

U.S. Pat. No. 6,283,285 to Ikebe et al. shows a disk storage case having a hub for engaging a central hole in the disk and a ring shaped projection surrounding the hub. The ring projects upwardly and contacts the disk to support the disk in a spaced relationship with the bottom wall of the case.

U.S. Pat. No. 6,405,859 to Ku shows a disk holding structure formed from multiple, injection molded pieces. The disk is gripped around the outside diameter in a single location.

U.S. Pat. No. 6,454,091 to Mendoza et al. shows a storage case for disks having a pair of formed arms extending from a central retaining hub. The hub engages a central hole in the disk and creates a downward force on the disk. The arms include upwardly projecting tabs that frictionally engage the periphery of the disk.

### SUMMARY OF THE INVENTION

The present disclosure defines a package for retaining a disc or other article. The package includes a thermoformed plate having a front side and a back side. A retaining well is formed in the back side of the plate and is dimensionally formed for receiving the disc or article. At least one engagement clip is integrally formed within the plate and positioned on a periphery of the retaining well. The clip includes a resilient hook portion for surrounding an edge of the disk or article that is received in the retaining well. The hook applies a resilient retaining force on the disk or article in the direction of the back side of the plate such that the hook frictionally positions the disk or article in contact with the plate.

In a further aspect of the disclosure, the package may include a support member secured to the back side of the plate and covering the well. Further, the retaining well may be defined by a planer central portion and a surrounding rim extending outwardly and away from the plane of the central portion. The central portion may include dimensions substantially equivalent to the disk and the rim of the plate is preferably positioned outwardly of a disk when retained within the well.

In a further aspect of the disclosure, the package may include a peripheral flange. Further, the central portion and the flange may be formed in parallel planes and connected by the rim. In a further aspect of the package, the rim may be formed at an acute angle with respect to the plane of the central portion. Further, the support member may extend outwardly of the peripheral flange.

In a further aspect of the disclosure, the package engagement clip may include an expanded portion extending outwardly from the front side of the plate. Further, the hook portion may include an outer curved portion for surrounding an adjacent edge of the retained disk and connecting to an undercut portion for engaging the disk on an opposite side from its contact with the back side of the plate.

In a still further aspect of the disclosure, a combination of a package and an article may be provided. The article preferably includes an outer periphery and an edge portion having a defined thickness. The package includes a thermoformed plate having a front side and a back side. A retaining well is formed in the back side of the plate and is defined by a central portion for receiving the article. The central portion may have an outer periphery with dimensions substantially equivalent to at least a portion of the outer periphery the article. A surrounding rim extends outwardly from the outer periphery of the central portion. A peripheral flange may be provided around the periphery of the rim. A plurality of engagement clips are integrally formed within the central portion and are positioned at spaced locations around the outer periphery. Each of the clips preferably includes a resilient hook for surrounding the edge portion of the article and for applying a resilient retaining force on the edge of the article. The resilient hook portions are formed to position the article within the retaining well and to retain the article in frictional contact with the back side of the central portion. The hook portion of each clip is preferably connected to an expanded portion extending outwardly from the front side of the central portion. The hook portion is further defined by an outer curved portion extending in the direction of the back side of the central portion and formed to surround the edge of the article. The curved portion is connected to an undercut portion formed for engaging the edge portion of the article on an opposite side thereof from the back side of the central portion of the plate. In addition, the surrounding rim is connected to and supports the undercut.

Other features of the present invention and combinations of features will become apparent from the detailed description to follow, taken in conjunction with the accompanying drawings.

### BRIEF DESCRIPTION OF THE DRAWINGS

For the purpose of illustrating the invention, the drawings show one or more forms that are presently preferred. It should be understood that the invention is not limited to the precise arrangements and instrumentalities shown in the drawings.

FIG. 1 shows a perspective view of a package for retaining a disk in form contemplated by the present disclosure.

FIG. 2 shows a front side elevation of the package of FIG. 1.

FIG. 3 shows a right side elevation of the package of FIGS. 1 and 2.

FIG. 4 shows a top plan view of the package of FIGS. 1-3.

FIG. 5 shows a cross sectional view of a clip portion of the package with the cross section taken along line 5-5 in FIG. 2.

### DETAILED DESCRIPTION

In the figures, where like numerals identify like elements, there is shown an embodiment of a package designated by the numeral 10. As shown in FIG. 1, the package 10 is formed to retain an article and preferably a disk shaped article, such as a media disk (e.g., CD, DVD, etc.). The disk article is generally identified in the drawings by the numeral 12 and is shown in FIGS. 1-4 in phantom, as it is retained within the interior confines of the package 10. The package 10 is preferably thermoformed from a plastic material. As illustrated, the package 10 is of the type that is sometimes referred to as a blister pack. Other thermoformed packages may find applicability to the features contemplated herein, including clamshell packages, tri-fold packages, etc. As illustrated, the thermoformed package 10 includes a front plate portion 14 and a rear support portion 16. The disk 12 is retained by the plate 14 and located between the plate 14 and the support 16. As particularly shown in the cross section of FIG. 5, the plate 14 includes a front side 18 and a back side 20. The disk 12 is secured to the back side 20 of the plate 14 and the support is provided for enclosing the disk 12.

As shown in FIGS. 2-4, the plate portion 14 is dimensioned to surround the outer periphery of the disk 12, such that the body of the support 16 has a greater overall surface area than that of the plate 14. The plate 14 includes a peripheral flange 24 and a central portion 26. The central portion is generally formed in a single plane, with the flange 24 formed in separate, parallel planes. A surrounding rim 28 is positioned between the central portion 26 and the flange 24 and forms a transition between the two planes of the central portion 26 and the rear portions of the package. The rim 28 is preferably formed at an acute angle with respect to the plane of the central portion 26 and/or the flange 24. The central portion 26 and rim 28 create a retaining cavity or well 30 for receipt of the disk 12. The flange 24 surrounds the periphery of the rim 28.

The flange 24 of the plate 14 is secured to the support 16 in any convenient manner. For example, an adhesive or a heat seal may be used to secure the two parts 14, 16 and to encapsulate the disk 12 within the well 30. The seal may be peelable upon the application of a minimal force or may be more permanent, requiring cutting or a destructive force to be applied to the package to remove the disk. Inter-engaging tab elements or projections (not shown) may be formed in adjacent surfaces of the flange and the plate to create a frictional retention of the two parts. The plate may also be hingedly connected to the rear support, such as in a clamshell package or tri-fold package. Clamshell packages, tri-fold packages and similar thermoformed packages may also include a variety closing or sealing structures. These structures may include self-locking tabs, snaps, or other friction fit elements. In addition, adhesives, pressure sensitive tapes, labels, staples, heat seals, and similar forms of attachment may be provided.

A plurality of clip members 20 is provided within the plate 14 and serve to retain the disk 12 within the cavity 30 defined on the back side 20 of the plate 14. Three clips 20 are shown to be arranged at spaced locations on the periphery of the central portion 26. The clips 20 preferably bridge the central portion 26 of the plate 14 and the adjacent portions of the rim 28. Multiple clips are preferred. However, it is contemplated that a single clip member may be provided along with some additional disk engagement means (not shown). The additional engagement means may be provided in an opposing relation with the clip and may engage the edge of the disk or may support a central opening in the disk. Other variations are also possible.

As shown in cross section in FIG. 5, the clip member 20 includes a retaining hook portion that is connected to an expanded area 32 formed at the periphery of the central portion 26 of the plate 14. The expansion 32 projects outwardly from the front side 18 of the plate 14, creating a corresponding hollow bowl 34 within the back side 20 of the plate 14. The expansion 32 extends a short distance beyond the periphery of the central portion 26 and the disk 12. The hook is defined by an outer curve 36 and inward undercut 38. The undercut 38 is connected to the angled rim 28. The outer curved portion 36 and the undercut 38 are defined to engage a back side surface 40 of the disk 12 and preferably create a positional force on the disk 12. The positional force is directed against the disk 12 and in the direction of the back side 20 of the package plate 14, moving the front side 42 of the disk 12 into frictional contact with the back side 20 of the plate 14. This frictional force is contemplated to be sufficient to deter rotation of the disk 12 within the well 30 formed by the plate 14. The clips 12 are also dimensionally positioned such that the engagement of the undercut 38 with the back side surface (or edge) of the disk 12 provides an inward retaining force on the disk 12. Multiple clips 12, arranged at various opposing positions around the edge of the disk 12 join to fix the disk 12 within the well 30. The retaining force is contemplated to be resilient.

Assembly of the package will include the movement of the disk 12 into the well 30 formed on the back side 20 of the plate 14. The front edge of the rim of the disk 12 is forced over the undercut 38 of each of the clips 22. The plate material and formation of the clips is contemplated to permit the resilient deformation of the undercuts, which are located radially inward of the edge of the disk. The angled rim 28 on the plate 14 assists in centering the disk 12 and directing the disk edge into engagement with the undercut 38. To remove the disk 12 from the retained position on the back side 20 of the plate, a discharge force may be applied to the front side 18 of the central portion 26 of the plate 14. Alternatively, an edge of the disk 12 may be sufficiently exposed so as to permit the discharge force to be applied to the disk front surface 42. The discharge force causes the disk 12 to move around the undercut 38. The movement of the disk 12 around the undercut 38 is preferably performed without causing harm to the disk 12 or permanent deformation of the undercut 38 or rim 28 of the plate 14.

It is contemplated that the depth of the bowl 34 of the clip 22, the form of the outer curve 36 and the position of the undercut surface 38 combine to create the positional and retaining forces on the disk. This dimensional relationship is dependant upon, among other things, the thickness and stiffness of the disk, the material properties of the plate, and the formation process. The undercut within the hook element of the clip 22 in FIG. 5 may be formed within a vacuum or thermoforming process, without the need for movable mold surfaces. Once the heated plastic is formed on the mold, and sufficient time passes for the part to be at least partially cooled, the part may be ejected from the mold with a resilient deformation of the undercut occurring as it moves around the projection of the mold that form the outer curve.

The plate and support may be made of any number of materials. Preferably, the plate is made from a polyvinylchloride (PVC) material having a thickness of about 0.010 inches. The dimensions of the outer curve and the undercut are dependant on a number of factors, including but not limited to the desired frictional (positional) force on the disk against the rear side of the plate and the speed of formation. The overlap of the undercut within the mold may be considered aggressive in form, but can be adjusted to avoid deformation, within commercially viable molding times. The support may be formed from the same PVC material, from an alternative plastic material or from another material, such as paper or paperboard.

In one contemplated structure, the plate portion is transparent or clear and a printed design (and/or text) is provided on the support. A matching design is provided on the front side of the disk, which is exposed through the central portion of the plate. The disk graphics are integrated with the graphic design on the plate. Based on the positional force on the disk, created by the clips, the disk position is frictionally fixed and the integrate graphics remain aligned. In This manner, the package 10 may form a point-of-sale display for the media contents of the disk 12, with the disk design integrated into the packaging. A channel and hook formation 44 is provided on the top edge of the support 14 for hanging the package 10 on a hook in a storage or sales environment.

As illustrated, the central portion of the plate is substantially planer for receipt of the planer disk shaped article. Other article forms may be provided and the central portion may be formed to receive and secure the article. In addition, the central portion is not required to be formed in plane parallel to the plate flange or to the plane of any provided support member.

The present invention has been described and illustrated with respect to one or more exemplary embodiments. It should be understood by those skilled in the art from the foregoing that various other changes, omissions and additions may be made therein, without departing from the spirit and scope of the present invention, with the scope of the invention being described by the foregoing claims.

What is claimed is:

1. A package for retaining a disc, the package comprising:
a thermoformed plate, the plate having
a front side,
a back side,
a retaining well formed in the back side of the plate, the retaining well dimensionally formed for receiving a disc, and
at least one engagement clip integrally formed within the plate and positioned on a periphery of the retaining well, the clip having a resilient hook portion for surrounding an edge of a disk received in the retaining well and for applying a resilient retaining force on the disk toward the back side of the plate,
wherein the resilient hook engages a received disk and frictionally positions the disk in contact with the back side of the plate.

2. A package as in claim 1, further comprising a support member secured to the back side of the plate and covering the well.

3. A package as in claim 1, wherein the retaining well is defined by a planer central portion and a surrounding rim extending outwardly and away from the plane of the central portion.

4. A package as in claim 3, wherein the central portion has dimensions substantially equivalent to the disk to be retained, and the rim is positioned outwardly of the disk when retained within the well.

5. A package as in claim 3, further comprising a peripheral flange, the central portion and the flange formed in parallel planes and connected by the rim.

6. A package as in claim 5, wherein the rim is formed at an acute angle with respect to the plane of the central portion.

7. A package as in claim 6, further comprising a support member secured to the peripheral flange, the support member enclosing the well.

8. A package as in claim 7, wherein the support member extends outwardly of the peripheral flange.

9. A package as in claim 1, wherein the engagement clip comprise an expanded portion extending outwardly from the front side of the plate, and the hook portion having an outer curved portion for surrounding an adjacent edge of the retained disk and connecting to an undercut portion for engaging the disk on an opposite side from the back side of the disk.

10. A package as in claim 9, wherein the plate comprises a surrounding rim extending outwardly at an acute angle away from the plane of the central portion, and wherein the rim is connected to and supports the undercut of the hook portion of the clip.

11. A package for receiving and retaining a disc, the package comprising:
a thermoformed plate, the plate having
a front side,
a back side,
a retaining well formed in the back side of the plate, the retaining well defined by a planer central portion and a surrounding rim extending outwardly at an acute angle from the plane of the central portion, the central portion having dimensions substantially equivalent to a disk to be received with the rim positioned outwardly of a retained disk,
a peripheral flange, the central portion and the flange connected by the rim, and
a plurality of engagement clips, the engagement clips integrally formed within the plate and positioned at spaced locations around a periphery of the retaining well, each of the clips having a resilient hook portion for surrounding an edge of a disk and for applying a resilient retaining force on the disk, the resilient hook engaging a disk and positioning the disk in frictional contact with the back side of the plate, the hook portion connected to an expanded portion extending outwardly from the front side of the plate, the hook portion defined by an outer curved portion extending in the direction of the back side of the plate and formed to surround an edge of a disk, the curved portion connected to an undercut portion for engaging a disk on an opposite side thereof from the back side of the central portion of the plate, the rim connected to and supporting the undercut; and
a planer support member secured to the peripheral flange, the support member enclosing the well and a disk retained therein, and the support member extending outwardly of the peripheral flange.

12. A combination of a package and an article, the combination comprising:
an article having defined outer periphery and an edge portion, the edge portion having a defined thickness
a package having a thermoformed plate, the plate having
a front side,
a back side,
a retaining well formed in the back side of the plate, the retaining well defined by
a central portion defined to receive the article and having outer periphery with dimensions substantially equivalent to at least a portion of the outer periphery of the article, and
a surrounding rim extending outwardly from the outer periphery of the central portion, and
a plurality of engagement clips, the engagement clips integrally formed within the central portion of the plate and positioned at spaced locations around the outer periphery of the central portion, each of the clips having a resilient hook for surrounding the edge portion of the article and for applying a resilient retaining force on the edge of the article, the resilient hook engaging and positioning the article in frictional contact with the back side of the central portion within the retaining well, the hook connected to an expanded portion extending outwardly from the front side of the central portion, and the hook defined by an outer curved portion extending in the facing direction of the back side of the central portion and formed to surround the edge of the article, the curved portion connected to an undercut portion for engaging the edge portion of the article on an opposite side thereof from the back side of the central portion of the plate, the surrounding rim connected to and supporting the undercut.

13. The combination as in claim 12, wherein the article is a disk, the disk having a planer front side, a planer back side and a circular edge.

14. The combination as in claim 12, wherein the central portion is substantially planer and the surrounding rim is formed at an acute angle with respect to the plane of the central portion.

15. The combination as in claim 14, wherein the peripheral flange is formed in a plane spaced from the plane of the central portion.

16. The combination as in claim 15, wherein the package further comprises a flange connected to and surrounding the rim.

17. The combination as in claim 16, wherein the plane of the central portion is substantially parallel to plane of the flange.

18. The combination as in claim 17, wherein the package further comprises a support member secured to the flange, the support member enclosing the well and the article retained therein.

19. The combination as in claim 18, wherein the support member extends outwardly of the periphery of the flange.

20. The combination as in claim 19, wherein the support member is substantially planer.
